(19) United States
(12) Patent Application Publication
(10) Pub. No.: US 2010/0216101 A1
(43) Pub. Date: Aug. 26, 2010

(54) Method and device for teaching and/or calculating mathematics

(76) Inventor: Jarom Chung, Draper, UT (US)

Correspondence Address: TRASKBRITT, P.C., P.O. BOX 2550, SALT LAKE CITY, UT, 84110, US

(21) Appl. No.: 12/380,343

(22) Filed: Feb. 25, 2009

(51) Int. Cl. G09B 19/02; G09B 23/02; G09B 29/00

(52) U.S. Cl. 434/188; 434/195; 434/430

(57) ABSTRACT

A device and method for teaching, solving, and/or illustrating mathematical principles and equations is disclosed. The device comprises a set of increasing numerical values arrayed on a spectrum, each numerical value represented by a length, each length comprising a visual marker representative of the numerical value; wherein the visual marker is repeatedly displayed on the spectrum in a pattern corresponding to or at intervals in accordance with the visual marker's numerical value. Alternatively, the device may comprise a set of increasing numerical values on a spectrum, each numerical value represented by a length, each length comprising distinct visual markers representative of mathematical factors of the numerical value.

### FIELD OF INVENTION

The present invention relates to method and devices for teaching mathematics, and more particularly to methods and devices for teaching mathematical principles, equations, and calculations.

### BACKGROUND OF RELATED ART

Through years of study, scientists have determined that individuals learn in a variety of ways. For example, there are individuals that may be more adept at auditory learning, tactile learning, visual or graphic learning, and/or individuals who are kinesthetic learners, or people who learn from doing the action. Typically, an individual has a primary mode of learning with secondary and tertiary modes that follow.

If a principle or subject is taught by one method, for example a visual method, individuals who are more adept at a different method of learning may struggle with the principle. For examples, an individual that is more adept at kinesthetic or abstract learning may struggle with that principle or subject taught in a visual or abstract methods. Similarly, an individual that is more proficient at abstract learning may struggle with kinesthetically taught principles. However, the visual learners are at a disadvantage when it comes to mathematics and science as both subject areas typically are taught and/or learned kinesthetically and/or abstractly.

During a typical individual's early years, math is primarily a visual learning experience. For example, young students learn basic math principles, e.g., addition, subtraction, etc., by counting out objects or fingers. This provides a basis for mathematical education. As time progresses, however, mathematics are taught in a manner that is more abstract and computational, e.g., computing problems in homework, equations, etc. For individuals that struggle with abstract or kinesthetic learning, they can begin to struggle at mathematics.

Furthermore, the typical mathematical curriculum is compartmentalized, meaning that branches of mathematics, e.g., addition, subtraction . . . algebra, trigonometry, etc. are taught separately. As teaching and learning progress to higher level mathematics, e.g., linear algebra, calculus, etc., it becomes important to understand and comprehend the integration and cooperation of mathematical principles from many mathematical branches. This proves difficult for many individuals, as many of the principles are complex and abstract.

While there may currently exist tools, devices, or methods for teaching mathematical principles or equations, e.g., addition, subtraction, multiplication, division, such tools and devices are inadequate for teaching and integrating more complex, higher-level mathematics.

### BRIEF SUMMARY OF THE INVENTION

In one embodiment of the invention there is a device for teaching and calculating mathematical principles and equations. The device may comprise a first numerical value and a second numerical value represented by a first length and a second length, respectively. The first and second lengths may comprise first and second visual markers, respectively. The first and second lengths may be increasingly displayed as a spectrum. Additionally, the first visual marker may be repeatedly displayed on the spectrum in a pattern corresponding to, or at intervals in accordance with, the first numerical value.

In an additional embodiment, there may be a device configured to and/or for teaching, solving, and/or illustrating mathematical principles and equations may comprise a set of increasing numerical values on a spectrum. Each numerical value may be represented by a length. Each length may further comprise distinct visual markers representative of mathematical factors of the numerical value.

In another embodiment, there may be a method for teaching, solving, and/or illustrating mathematical principles. The method may comprise: assigning a first numerical value a first visual marker and a first length; assigning a second numerical value greater than the first numerical value, a second visual marker, and a second length; displaying the first and second lengths as a spectrum in accordance with the first numerical value and the second numerical value; and repeatedly displaying the first visual marker along the spectrum in a pattern corresponding to and/or at intervals in accordance with the first numerical value.

In various embodiments of the invention, the device for teaching and/or calculating mathematical equations may be embodied in methods and/or visual tools for teaching basic mathematical principles and calculating equations such as, but not limited to, addition, subtraction, multiplication, and division. Additionally, the device may be used for teaching and/or calculating more advanced mathematical principles and/or equations such as, but not limited to, Pre-Algebra, Algebra, Geometry, Trigonometry, Calculus, Linear Algebra, and so forth. Further, the device may be used for teaching and/or calculating principles and problems that are directly and/or indirectly related to mathematics, such as, but not limited to, physics, engineering, and/or so forth.

Other features and advantages of the present invention will become apparent to those in the art through consideration of the ensuing description, the accompanying drawings, and the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1A and 1B are schematic views of a device and method for teaching and calculating mathematical principles and equations, according to various embodiments of the invention;

FIG. 2 is schematic view of a device and method for teaching and calculating mathematical principles and equations, according to various embodiments of the invention;

FIG. 3 is a schematic view of a device and method for teaching and calculating mathematical principles and equations displayed, coordinated with, and/or incorporated as part of a Cartesian grid and/or coordinate system, according to one embodiment of the invention;

FIG. 4 is a perspective view of a three-dimensional device and method for teaching and calculating mathematical principles and/or equations, according to one embodiment of the invention;

FIGS. 5A through 5L are a series of schematic top cross-sectional views of a three-dimensional device and method for teaching and calculating mathematical principles and/or equations, according to various embodiments of the invention;

FIGS. 6A through 6L is a series schematic side cross-sectional views of a device and method for teaching and calculating mathematical principles and/or equations, according to various embodiments of the invention;

FIGS. 7 and 8 are schematic views of a device and method for teaching and calculating mathematical principles and equations, according to various embodiments of the invention;

FIG. 9 is a schematic view of a device and method for teaching and calculating addition and subtraction equations and/or principles, according to one embodiment of the invention;

FIGS. 10A and 10B are schematic views of a device and method for teaching and calculating multiplication equations and/or principles, according to various embodiments of the invention;

FIGS. 11 through 13 are schematic views of a device and method for teaching and calculating mathematical principles and/or equations, according to various embodiments of the invention;

FIGS. 14 and 15 are schematic views of a device and method for teaching and calculating linear functions and algebraic principles, according to various embodiments of the invention;

FIGS. 16 and 17 are schematic views of a device and method for teaching and calculating geometric principles and equations, according to various embodiments of the invention;

FIG. 18 is a schematic view of a device and method for teaching and calculating trigonometry principles and equations, according to one embodiment of the invention;

FIGS. 19 through 21 are schematic views of a device and method for teaching and calculating calculus principles and equations, according to various embodiments of the invention;

FIGS. 22 through 25 are schematic view of a device and method for teaching and calculating linear algebraic principles and equations, according to various embodiments of the invention;

FIGS. 26 and 27 are schematic views of a device and method for teaching and calculating physics principles and equations, according to one embodiment of the invention; and

FIG. 28 is a schematic view of a device and method for teaching and solving engineering related principles and problems.

### DETAILED DESCRIPTION

Although the foregoing description contains many specifics, these should not be construed as limiting the scope of the present invention, but merely as providing illustrations of some representative embodiments. Similarly, other embodiments of the invention may be devised that do not depart from the spirit or scope of the present invention. Features from different embodiments may be employed in combination.

In one aspect, the various embodiments of the device and method for teaching and/or calculating mathematics provide a basis for a visual teaching of mathematical principles and calculating mathematical equations. Additionally, the various embodiments of the device and method assist with difficult and abstract mathematical principles by visually teaching mathematics and numbers.

Reference will now be made to the drawings. Like elements are identified by like numerals. The drawings are not necessarily to scale.

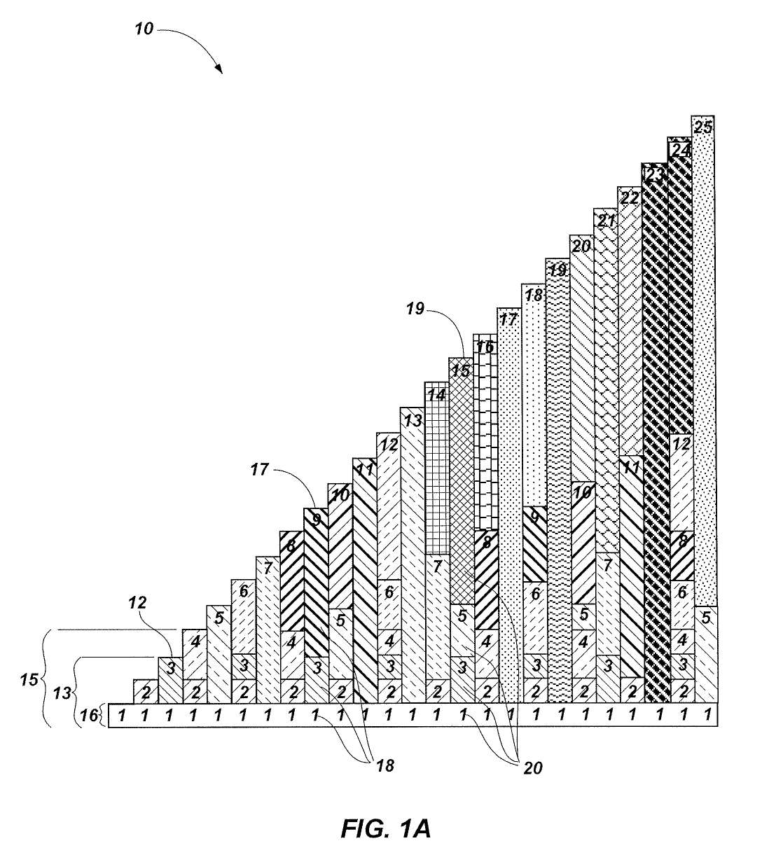

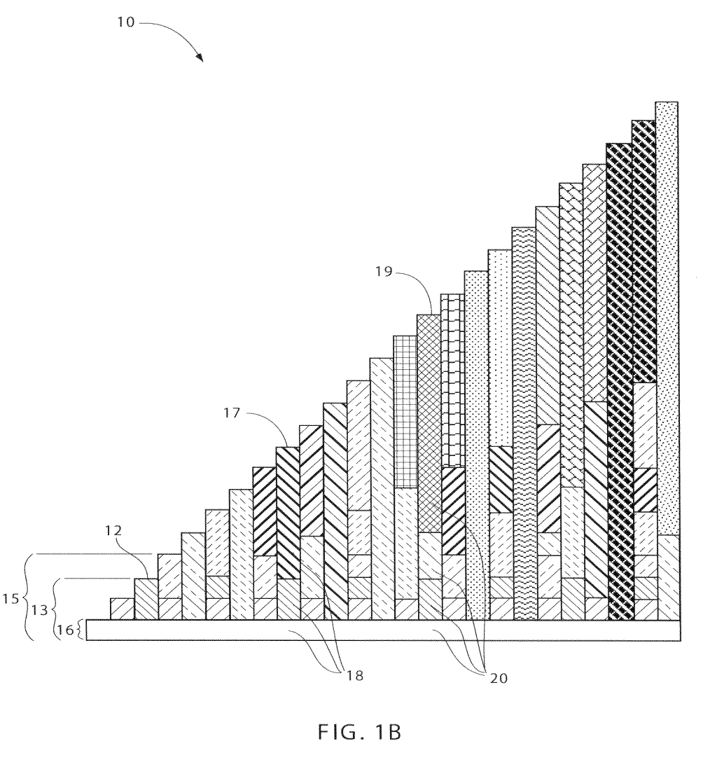

Referring to FIGS. 1A and 1B, there is shown a device 10 for teaching and calculating mathematical principles and/or equations. The device 10 comprises a plurality of increasing and/or consecutive numerical values displayed on a spectrum, which may also be characterized as a graphical spectrum. It is contemplated that the numerical value may be any type and/or kind of numerical value contemplated in the art, such as, but not limited to, an integer, a natural number, a negative number, rational number, irrational number, real numbers, complex numbers, computable numbers, prime numbers, and so forth.

Illustrated in FIGS. 1A and 1B, each numerical value comprises a distinct length 13. As the numerical values associated with and/or corresponding to the length increase, the length increases. In a non-limiting example, there is a first numerical value, e.g., three (3) comprising and/or represented by a first length 13. There is also a second numerical value, e.g., four (4) comprising and/or represented by a second length 15. In one embodiment, as the numerical values increase or decrease along the device 10, the lengths or heights 13, 15, associated therewith increase or decrease approximately proportional to the numerical values.

In an additional embodiment, each length is measured in units or squares. The number of units, or squares, per length is dependent upon and/or corresponds to the numerical value of a particular length. For example, the numerical value one (1) and its corresponding length 16 comprise a measurement of one (1) unit or square; the numerical value two (2) and its corresponding length comprises two (2) units or squares; the numerical value three (3) and its corresponding length comprises three (3) units or squares; and so forth.

Also shown in FIGS. 1A and 1B, each numerical value is represented throughout the device 10 by a distinct visual marker 12. It is contemplated that the visual marker 12 may be any type and/or kind of visual marker contemplated in the art, such as, but not limited to, a color, a pattern, a symbol, and/or so forth. In an exemplary embodiment, each different numerical value is represented by a different color or different shade, tint, or hue of a color. For example, the numerical value one (1) is represented by a white color, the numerical value two (2) is represented by a tan color, the numerical value three (3) is represented by a pink color, and so forth.

As shown in FIGS. 1A and 1B, each length of the device comprises the visual markers representative of mathematical factors of the numerical value associated with each particular length. In a non-limiting example, a length 17 corresponding to a numerical value, such as nine (9), comprises a visual marker representative of the numerical value nine (9), as well as those visual markers corresponding to the mathematical factors of the length nine (9) 18, e.g., one (1), three (3), and nine (9).

In another non-limiting example, also shown in FIGS. 1A and 1B, the length 19 corresponding to the numerical value, fifteen (15), comprises: the visual marker representative of the numerical value fifteen (15) and the visual markers representative of the mathematical factors of fifteen (15) 20, e.g., one (1), three (3), five (5), and fifteen (15).

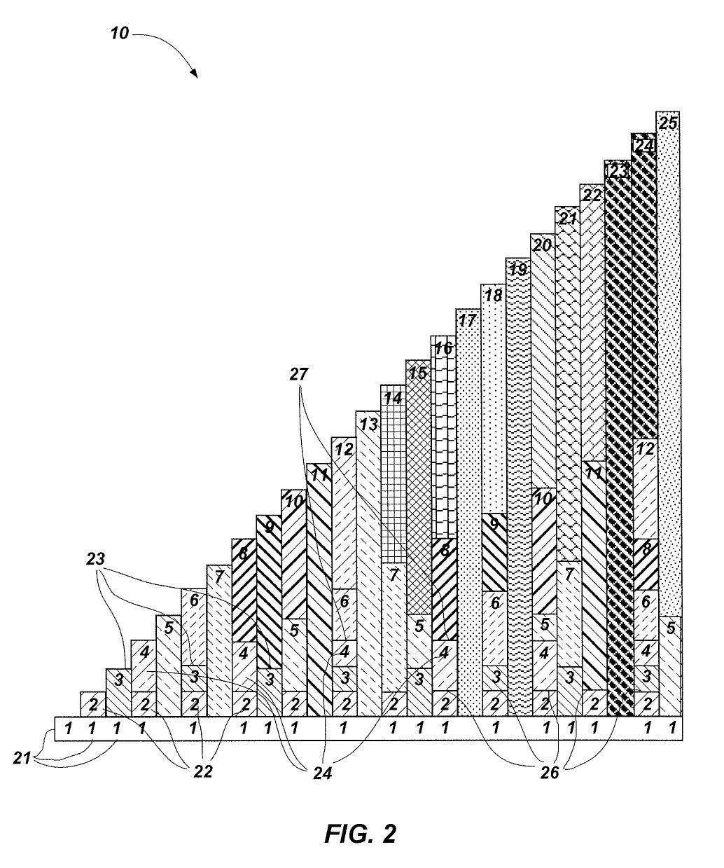

As shown in FIG. 2, the plurality of visual markers 12, each representative of a numerical value, are displayed, arrayed, and/or otherwise arranged at repeated intervals on the device 10 in accordance with each visual marker's numerical value. For example, the visual marker representative of the numerical value one (1) 21 is repeatedly displayed at intervals on the spectrum in accordance with the numerical value one (1), or at each length 13. Similarly, the visual marker representative of the numerical value two (2) 22 is repeatedly displayed on the device 10 at intervals of two (2), or every other length 13. Similarly, the visual marker representative of the numerical value three (3) 23 is repeatedly displayed at intervals of three (3); and so on.

In one novel aspect of the invention, as can be seen throughout the FIGS., displaying the plurality of visual markers 12 at repeated intervals along the device 10 in accordance with each visual marker's numerical value results in each length 13 of the device 10 including the visual markers representative of the mathematical factors of each length 13. For example, repeatedly displaying the visual marker representative of number four (4) at intervals of four (4) along the device 10, results in the visual marker of numerical value four (4) being present or otherwise included in the visual markers of those lengths 24 in which four (4) is a mathematical factor, e.g. eight (8), twelve (12), sixteen (16), etc.

In an additional embodiment, shown in FIG. 2, the plurality of visual markers 12 representative of a particular numerical value are repeatedly displayed on the device 10 such that a first end 26 of each visual marker representative of the particular numerical value are aligned throughout the device 10. For example, the first end 26 of each visual marker representative of the numerical value two (2) is aligned on the device 10. Similarly, the first end 27 of each visual marker representative of the numerical value four (4) is aligned on the device 10. The first end of the visual marker representative of the numerical value five (5) is aligned on the device 10, and so on.

In yet another embodiment, the first end 26 of each visual marker representative of the particular numerical value comprises a substantially equal measurement as the particular visual marker is repeatedly displayed throughout the device 10. For example, each first end 26 of the visual marker representative of the numerical value two (2) comprises a measurement of two units in height or length, or two squares. Similarly, the first end 27 of each visual marker representative of the numerical value four (4) comprises a measurement of four units in height or length, or four squares, and so on.

Illustrated in FIGS. 1A and 1B, the numerical values represented by the lengths 13 and/or visual markers 12 may or may not be visually printed and/or displayed on the device 10. The printing or displaying of the numerical values may be accomplished in any manner contemplated in the art. By way of example only, as illustrated, the numerical values may be printed and/or displayed in or around each corresponding visual marker 12 and/or length 13.

Additionally, while many of the FIGS. (e.g., FIGS. 1, 2-3, 8-20,-23, 25, and 27-28) include numerical values printed and/or displayed in or around each visual marker throughout the device 10, the displayed numerical values are present to clarify and illustrate one or more embodiments of the inventions. As previously described, it is contemplated that the numerical values represented by the lengths 13 and/or visual markers 12 may or may not be printed and/or displayed on the device 10.

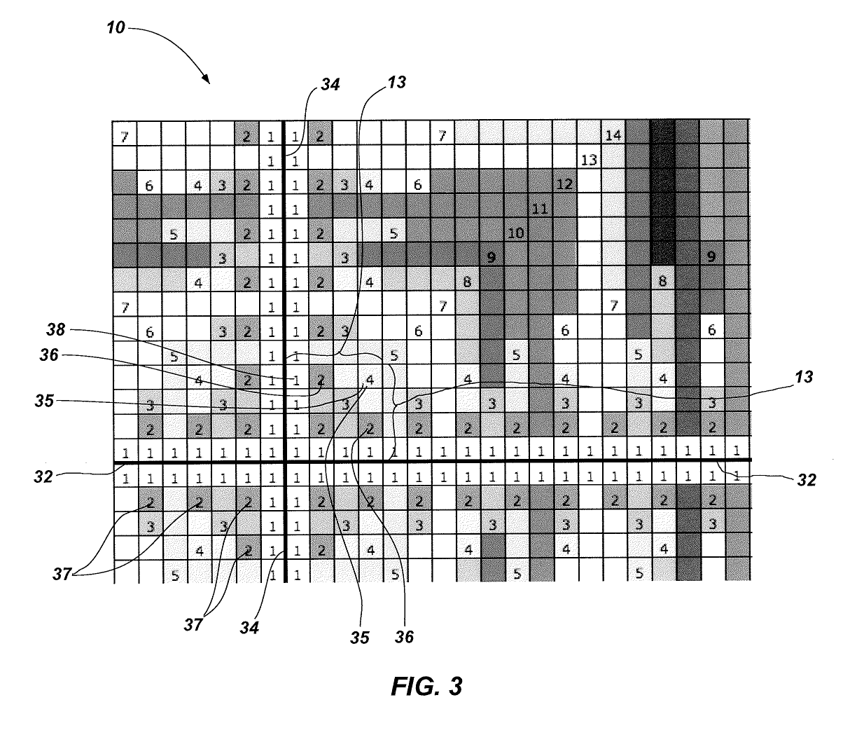

FIG. 3 is a schematic view of the device 10 and method displayed, coordinated with, and/or incorporated as part of a Cartesian grid and/or coordinate system. As shown, the device 10 and method comprise a first axis 32 and a second axis 34. In one embodiment, the first and second axes 32, 34 correspond to the X and Y axes, respectively, of the Cartesian grid system.

As shown in FIG. 3, the first and second axes 32, 34 comprise a set of increasing numerical values arrayed on the device 10, each numerical value represented by and/or corresponding to a length 13. Each length 13 comprises visual markers 12 representative of the mathematical factors of the length 13, or numerical value corresponding to the length 13. In a non-limiting example, the numerical value four (4) is represented as a length 13 extending from the first axis 32 and the second axis 34. Also shown, the length 13 represented by the numerical value four (4) comprises those visual markers representative of the mathematical factors of the numerical value four (4), e.g., four (4) 35, two (2) 36, and one (1) 38. In the non-limiting example shown, each visual marker comprises a distinct color. Accordingly, the quantity of visual markers in each length 13 is dependent on the quantity of mathematical factors corresponding to each numerical value associated with the length 13.

Similar to previous embodiments of the invention, the visual markers 37 are arrayed, and/or otherwise arranged at repeated intervals on the first and second axes 32, 34 in accordance with each visual marker's numerical value. In a non-limiting example, shown in FIG. 3, the visual marker representative of the numerical value two (2) 37 is repeatedly displayed along the first and second axes 32, 34 at intervals of two, or every other length. Displaying the visual markers 37 at repeated intervals along the first and second axes 32, 34 in accordance with each visual marker's numerical value results in each length 13 of the device 10 including the visual markers representative of the mathematical factors of each length 13.

In an additional embodiment, each numerical value and corresponding length 13 corresponds to each numerical value of the Cartesian coordinate system. For example, the length corresponding to the numerical value four (4) 13 comprises a length number of units, and/or measurement equal to fourth position on the coordinate system.

Additionally, it is contemplated that the end portion, or first end 26 of each visual marker corresponds to the Cartesian coordinate position of each visual marker's numerical value. For example, the visual marker representative of number four (4) extending from the first axis 32 comprises a first end at the x, y coordinates (4, 4), (4, 8), (4, 16), (4, 24) and so forth. In a similar pattern, the visual marker representative of three (3) comprises a first end at coordinates (3, 3), (3, 6), (3, 9), (3, 12) and so forth.

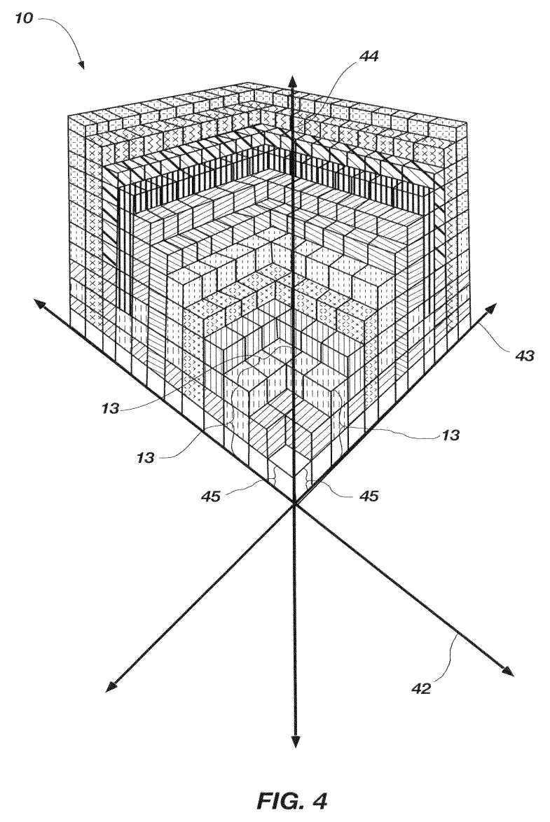

As shown in FIGS. 4 through 6, the device 10 and method comprise a set of increasing consecutive numerical values displayed on a three-dimensional device. Similar to previous embodiments, each distinct numerical value corresponds to and/or is represented on the three-dimensional device 10 as a length 13 and visual markers that correspond to the mathematical factors of the length 13.

FIG. 4 is a schematic perspective view of the device 10 and method in a three-dimensional embodiment. As shown, the three-dimensional device 10 comprises a first axis 42, a second axis 43, and a third axis 44. In a non-limiting example, it is contemplated that the first, second, and third axes 42, 43, 44 may correspond to the x, y, and z axes, respectively, of the Cartesian coordinate system.

As shown in FIG. 4, the first, second, and third axes 42, 43, 44 comprise a set of increasing numerical values arrayed on the device 10, each numerical value is represented by a length 13. Each length 13 comprises visual markers representative of the mathematical factors of the length 13, or numerical value corresponding to the length 13.

Similar to previous embodiments, the quantity of visual markers in each length 13 is dependent on the quantity of mathematical factors corresponding to each numerical value associated with the length 13. By way of example only, shown in FIG. 4, the length 45 representing the numerical value one (1) 45 comprises a single visual marker, as the numerical value one (1) has a single mathematical factor, one.

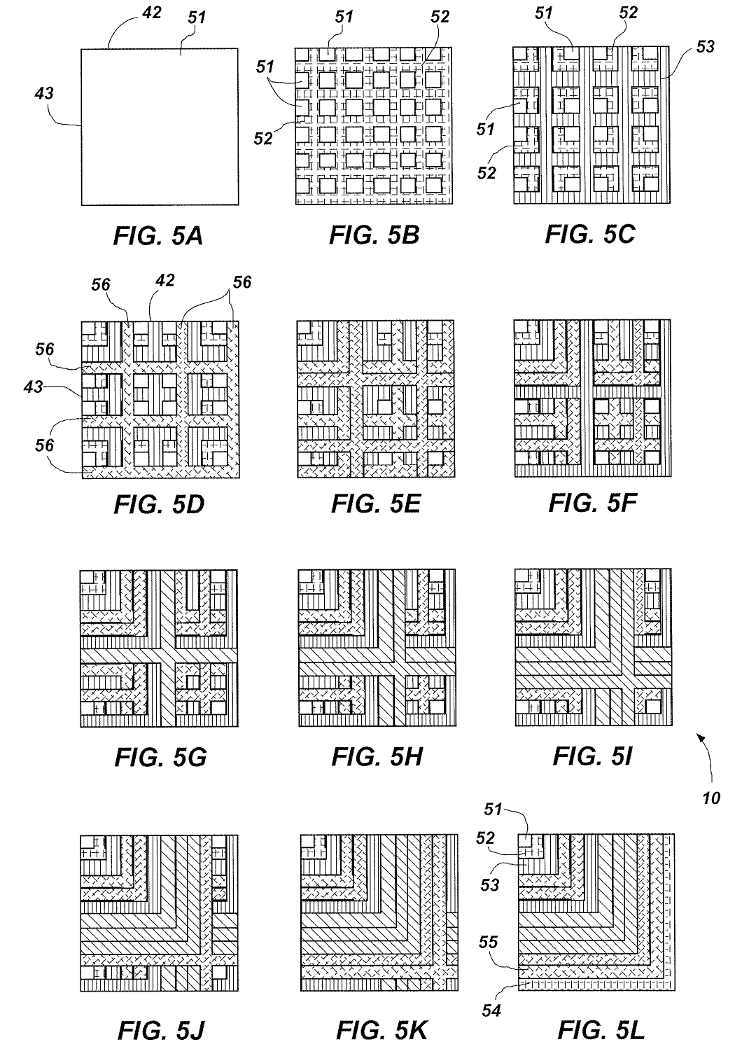

FIGS. 5A through 5L illustrate a series of elevational views taken along the third axis 44 in relation to the plane of the first and second axis 42, 43 of FIG. 4. For example, FIG. 5A is a top view of the lengths representing the numerical value one (1) 51 extending from the first, second, and third axes 42, 43, 44. FIG. 5B is a top view of the lengths representing the numerical value two (2) 52 overlaid on the lengths representing the numerical value one (1) 51. FIG. 5C is a top view of the length representing the numerical value three (3) 53 overlaid on the lengths representing the numerical values of one (1) 51 and two (2) 52, and so on until FIG. 5L, which is a top view of the length representing the numerical value twelve (12) 54 overlaid on the lengths representing the numerical values one (1) 51 through eleven (11) 55.

As can be seen in FIGS. 5A through 5L, the plurality of visual markers form patterns along the first, second, and third axes 42, 43, 44 corresponding to each visual marker's particular numerical value. For example, shown in FIG. 5D, the visual marker representative of the numerical value four (4) 56 is visible at intervals of four along the first and second axes 42, 43.

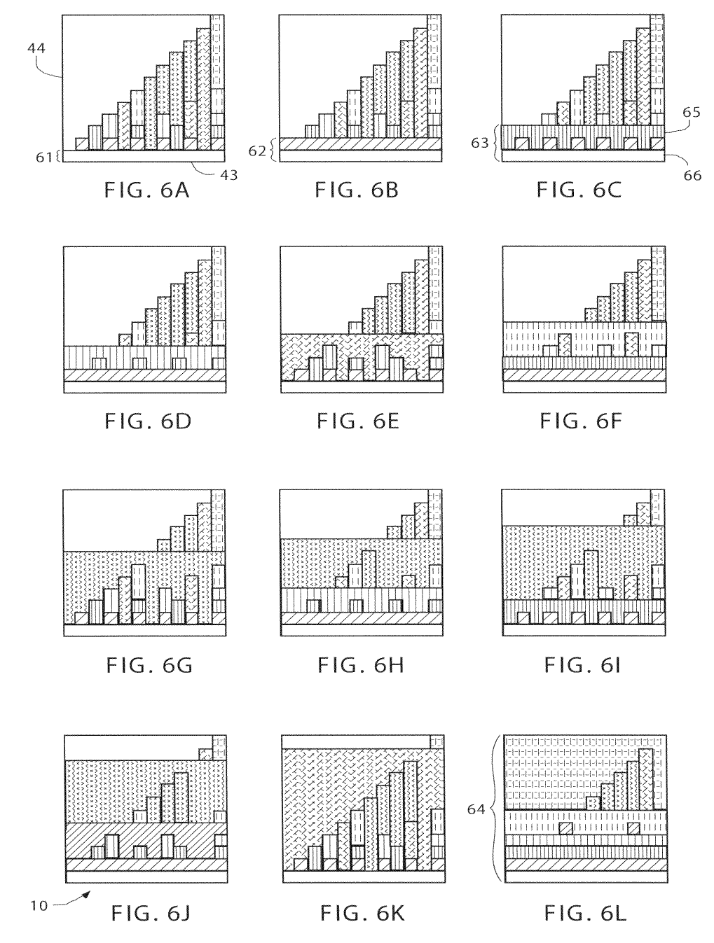

FIGS. 6A through 6L illustrate a series of side views taken along the first axis 42 in relation to the plane of the second and third axes 43, 44 of FIG. 4. For example, FIG. 6A is a side view of a length representative of the numerical value one (1) 61; FIG. 6B is a side view of a length representative of the numerical value two (2) 62; FIG. 6C is a side view of a length representative of the numerical value three (3) 63; and so on until FIG. 6L, which is side view of a length representative of the numerical value twelve (12) 64.

Additionally shown in FIGS. 6A through 6L, each length comprises the mathematical factors of the numerical value represented by the length. For example, shown in FIG. 6C, a length representative of the numerical value three (3) 63 comprises two visual markers that correspond to the numerical values three (3) 65 and (1) 66, both mathematical factors of three (3).

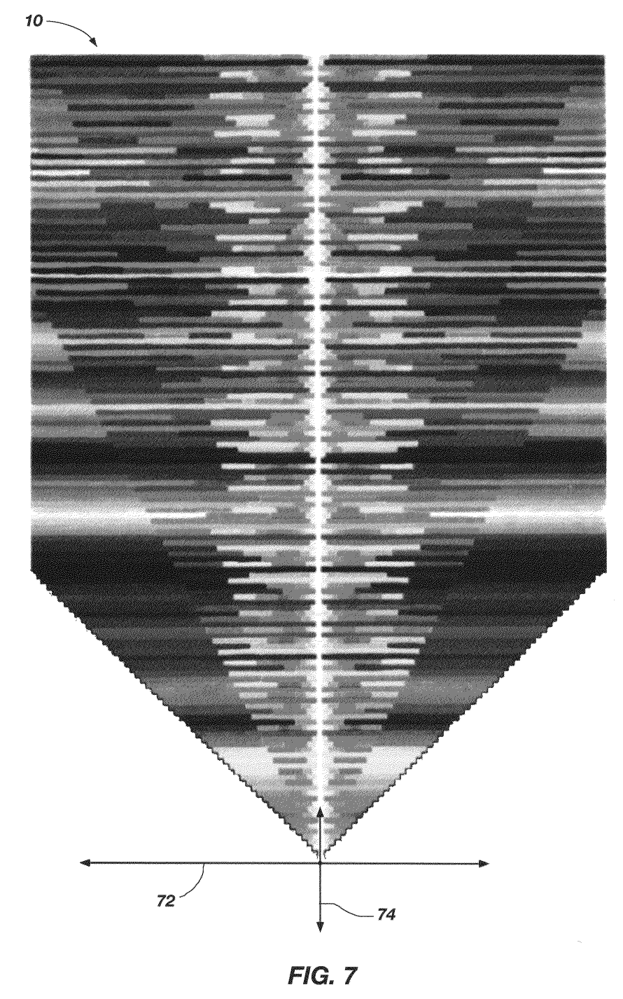

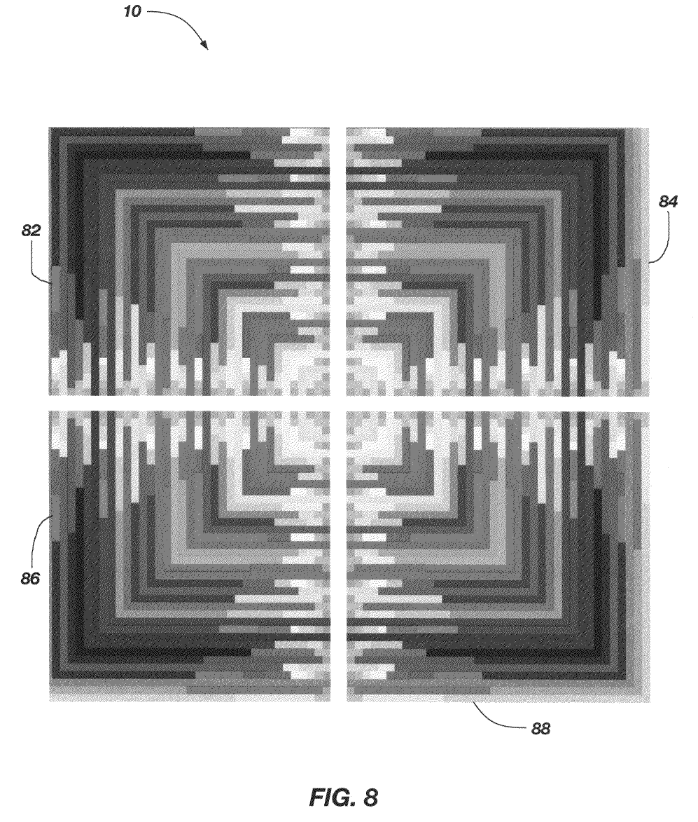

FIGS. 7 and 8 are schematic representations illustrating the device 10 encompassing a potentially ever-increasing set of numerical values, e.g., from one (1) to infinity (∂), from negative one (−1) to negative infinity (−∂), etc. Advantageously, because each visual marker representative of a numerical value is displayed, arrayed, and/or otherwise arranged at repeated intervals on the device 10, as previously described, a full range of numerical values, e.g., one (1) to infinity (∂), and their displayed lengths 13 comprise visual markers representative of the mathematical factors of the numerical value and length 13. Accordingly, calculating and visualizing higher numerical values, e.g., ten thousand (10,000), sixty-four thousand nine hundred ninety-two (64,992), etc., on the device 10 and method can be visually displayed, executed, and/or accomplished in a similar manner to lower, more numerical values, e.g., four (4), sixteen (16), etc.

In one embodiment, it is contemplated that the device 10 and method visualizes and/or displays an ever-increasing set of numerical values in all quadrants, as represented by the Cartesian coordinate system. Shown in FIG. 7 is an embodiment of a device 10 and method visualized and/or displayed as a potentially ever-increasing set of numerical values and/or lengths 13 in a X-Y Cartesian coordinate system. In FIG. 7, positive and negative numerical values of the Y-axis 74 and the positive numerical values of the X-axis 72 are shown. In the non-limiting example shown, each visual marker comprises a distinct color.

As shown in FIG. 8, the device 10 and method may comprise and/or embody any and/or all four quadrants 82, 84, 86, 88 of the two-dimensional Cartesian coordinate system. In additional embodiments, it is contemplated that the device and method may comprise and/or embody any and all of the eight quadrants of the three-dimensional Cartesian coordinate system. In the non-limiting example shown, each visual marker comprises a distinct color.

It is contemplated that the device 10 may be oriented and/or displayed in variety of orientations. For example, the device 10 may be oriented such that the plurality of increasing lengths forms columns, each column having a height. Alternatively, the device 10 may be oriented such that the plurality of increasing lengths and visual markers form rows, each row having a length.

In still another embodiment, there is a method for teaching, solving, and/or illustrating mathematical principles and equations. The method may comprise: assigning a first numerical value a first visual marker and a first length; assigning a second numerical value a second visual marker and a second length; displaying the first and second lengths on a spectrum in accordance with the first numerical value and the second numerical value; and repeatedly displaying the first visual marker and/or the second visual marker along the spectrum at intervals in accordance with the first numerical value.

In yet another embodiment of the invention, the method, device, and embodiments described herein, and/or combinations and/or portions thereof can be embodied in a computer-readable medium stored with a program and/or instructions for causing a system to display and/or operate the device and embodiments described herein. The computer-readable medium, or computer-media storage medium, can comprise instructions that, when executed by a processor, cause the processor to perform instructions for operating a spectrum for teaching and/or calculating mathematical principles and/or equations. The instructions may comprise: assigning a first numerical value, a first visual marker, and a first length; assigning a second numerical value greater than the first numerical value, a second visual marker, and a second length; displaying the first and second visual markers on a spectrum in accordance with the first numerical value and the second numerical value; and repeatedly displaying the first visual marker along the spectrum in a pattern corresponding to, or at intervals in accordance with, the first numerical value.

In still another embodiment, it is contemplated that the computer-readable medium may further comprise instructions for executing and/or configuring any of the embodiments and examples as described herein, or contemplated from the examples and embodiments herein. In a non-limiting example, the device 10 and method are configured to, and/or include instructions for, executing and calculating a plurality of mathematical equations. Additionally, the device 10 and method may be configured to and/or include instructions for displaying one more mathematical equations as well as any solutions to those mathematical equations as part of the device 10.

In one embodiment, the computer-readable medium comprises instructions for displaying and/or printing the numerical value. In a non-limiting example, there are instructions for visually displaying each numerical value on an output device, such as a monitor, screen, and/or printout. Alternatively, there may be instructions to visually display and/or print the numerical value in response to a command and/or instruction from an input device such as, but not limited to, a keyboard or a mouse.

In another embodiment, the computer-readable medium comprises instructions for displaying and maintaining a graphical user interface (GUI). The GUI may enable a user to interact, manipulate, and/or adjust the device 10 and method to a particular need or desire. By way of example only, the GUI may enable a user to adjust the device to suit a particular area of mathematics and/or equation.

In yet another embodiment of the invention, the computer-readable medium, the instructions, and/or portions thereof may be remotely accessible and/or remotely stored. The remote access and/or storage of the instructions may be via remote servers, databases, etc., and may be accessible via one or more networks and/or network configurations.

In various additional embodiments of the invention, the device 10 and method may be incorporated into, included as part of, and/or otherwise illustrated through one or more tools or other mediums. The tools and/or other medium may assist a user to view, modify, and/or adapt the device 10 and method to suit a need or desire. Some of theses tools or mediums may include charts, toys, graphical illustrations, and so forth. In a non-limiting example, the device 10 and method may be incorporated as part of a kaleidoscope.

### EXAMPLES

The following examples and description provide exemplary embodiments and/or exemplary methods of use for the device 10 and method for teaching and calculating mathematical principles and equations. As is apparent throughout the following examples, a distinct advantage provided by the device 10 and method is a visual teaching and representation of the principles of a wide range of mathematical subjects and equations.

Additionally, the device and method 10 are particularly advantageous for teaching and/or providing a visual representation of mathematical principles and the many relationships between numerical values. Some non-limiting examples of applicable principles include: factorization, factor pairs, perfect squares, square roots, prime numbers, greatest common factor, greatest common denominator, and least common multiple. The following examples represent a small fraction of the potential mathematical principles and equations to which the device and method 10 are applicable.

### Example 1

### Addition/Subtraction

The principles of addition and subtraction are based upon “adding to” or “taking away from” a number (counting forward or backward). Thus, using the device 10 and method, an equation may be solved and/or a principle visually learned and/or taught.

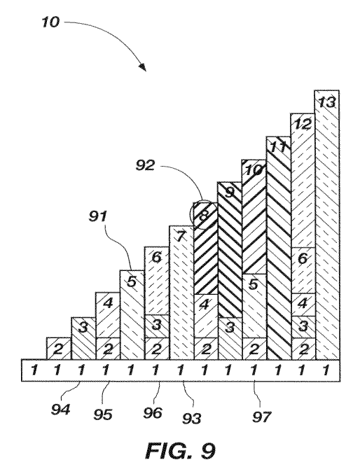

FIG. 9 illustrates the equation 5+3=8. To solve the equation, an individual, or set of instructions begins at the length representative of one of the numerical values in the equation, e.g., number five (5) 91 and then adds the additional number three (3) by counting three lengths to the right in the positive direction. In counting three lengths to the right, an individual, or set of instructions, arrives at the length representative of the solution 92, or the numerical value (eight) 8 92.

Also shown in FIG. 9 is the equation 7−4=3. To solve the equation an individual, or set of instructions, starts at the length representative of number seven (7) 93 and subtracts four (4) by counting four lengths to the left in the negative direction, thus arriving at the length representative of the solution 94, or the numerical value three (3) 94.

In another embodiment, the device 10 and method provide a novel and visual method for teaching the associative properties of addition. The associative properties of addition refer to the order by which numerical values added together has no bearing on the solution, e.g., 4+6=6+4. While this principle can additionally be taught by calculating equations, the device 10 and method provide a visual illustration of the principle.

As shown in FIG. 9, the equations 4+6=10 and 6+4=10 may be visually taught by moving six lengths to the right of, or in the positive direction from the length representative of four (4) 95 as well as moving four lengths to the right of, or in the positive direction from, the length representative of number (6) 96, respectively. As shown, both equations arrive at the length representative of the solution, or number ten (10) 97.

### Example 2

### Multiplication

In one embodiment, because multiplication is primarily based upon the mathematical factors of a numerical value, the device 10 and method may be used to visually teach and calculate multiplication equations. In one aspect, the device 10 and method assist and enable multiplication to become a more concrete and visual concept, rather than just an abstract equation.

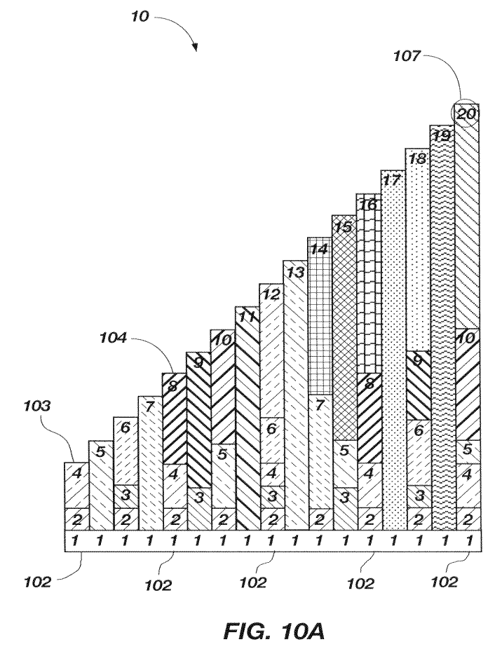

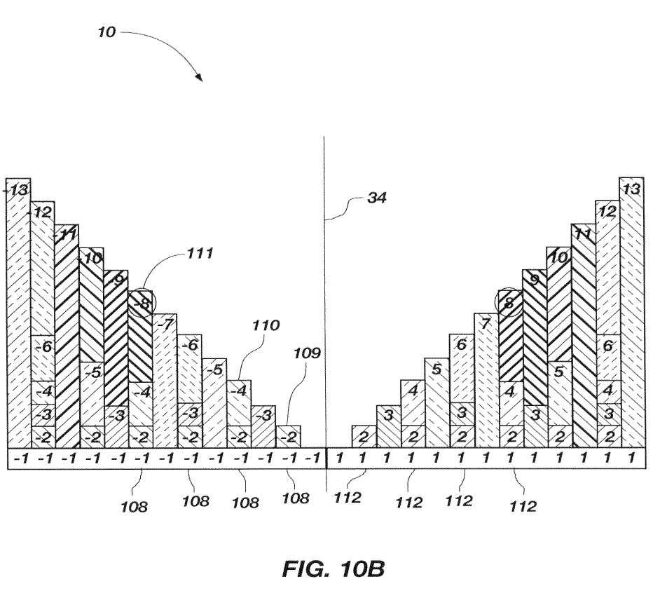

FIG. 10A illustrates the equation 5×4=20. In principle, multiplication may be defined as the sum of a number of groups and the amount in each group. For example, in the equation 5×4=20, the solution is the sum of five groups, each group containing an amount of four (4). To solve the equation an individual marks or otherwise visualizes the length representative of one of the numerical values in the equation, e.g., four (4) 102 and then counts out or marks five (5) visual marker representative of the numerical value four (4) 102 to the right, or in the positive direction. As shown, the first four (4) 102 corresponds to the length representative of the numerical value four (4) 103, the second four (4) 102 corresponds to the length of eight (8) 104 and so on. The fifth four (4) 102 corresponds to the visual marker associated with the numerical value of the solution, or twenty (20) 107.

It is contemplated that any numerical component of a multiplication equation may be used in teaching and determining the solution of the equation. For example, in the equation 5×4=20, the solution may be determined and/or taught by visualizing four groups of five on the device and method, rather than five groups of four, as previously described.

### Example 3

### Multiplication With Negative Numbers

Similar to the multiplication methods previously described, the device 10 and method may be used to teach and calculate multiplication principles and equations involving negative numbers. For example, the equation 4×−2=−8 may be visualized on a negative portion of the device 10 and method. Similar to multiplication using positive numbers, the equation asks for the sum of four groups of negative two (−2). In accordance with this principle, as illustrated in FIG. 10B, to solve the equation an individual, or set of instructions marks, counts, or otherwise visualizes four groups of the visual marker representative of negative two (−2) 108 on the device 10. As shown, the first negative two (−2) corresponds to the length representative of the numerical value negative two (−2) 109, the second corresponds to the visual marker of negative four (−4) 110 and so on. The fourth negative two (−2) corresponds to the length representative of the numerical value of the solution, or negative eight (−8) 111.

In one embodiment, illustrated in FIG. 10B, to calculate and teach equations involving multiplication of negative numbers, number groups are counted in the negative direction, or towards the left of the device 10. In contrast, on the right portion of FIG. 10B, to calculate and/or teach equations involving the multiplication of positive numbers, number groups are counted in the positive direction, or toward the right of the device ten (10). As shown, to solve the equation 4×2=8, four groups of two (2) 112 are counted to the right of the device 10.

In another embodiment, the device 10 provides a novel and visual method for teaching the associative properties of multiplication. The associative properties of multiplication refer to the order by which numerical values added together does not affect the resulting solution, e.g., 2×3=3×2. While these associative properties can additionally be taught by calculating equations, the device 10 provides a visual illustration of the principles behind the associative properties of multiplication.

As can be visualized in FIG. 10B, the equations 2×3=6 and 3×2=6 may be visually taught and/or solved. The equation 2×3=6 is shown by visualizing, marking, and/or otherwise counting two groups of three (3), yielding the visual marker representative of the solution, or six (6). Similarly, 3×2=6 is shown by three groups of two (2), also yielding the numerical value of the solution, or six (6).

### Example 4

### Factorization and Factor Pairs

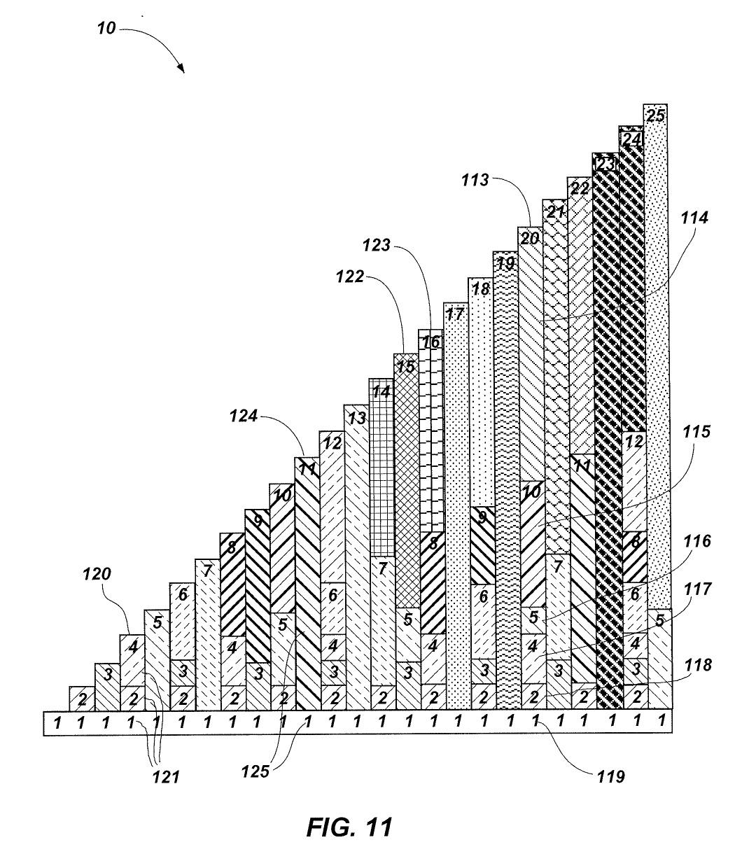

In an embodiment of the invention, shown in FIG. 11, the device 10 and method may be used to teach and/or determine the mathematical factors and/or factor pairs of one or more numerical values. As previously described, each length 13 comprises a visual marker representative of the numerical value of the length 13 in addition to those visual markers representative of the mathematical factors of the length 13. Accordingly, to determine the factorization and/or factor pairs of a particular numerical value, an individual, or set of instructions, need only locate the particular numerical value on the device 10 to determine the factorization of the numerical value.

For example, illustrated in FIG. 11 is the problem: find the factors and factor pairs of twenty (20). To find the factors of twenty (20), an individual locates the length representative of the numerical value twenty (20) 113 on the device 10. Each visual marker 12 part of length twenty (20) 113 is a factor of twenty (20) e.g., in descending order twenty (20) 114, ten (10) 115, five (5) 116, four (4) 117, two (2) 118, and one (1) 119.

Additionally shown in FIG. 11, the device 10 can be used to solve for and determine the factor pairs of a numerical value. For example, the factor pair of the uppermost visual marker 114, or highest numerical value of the length 113 is the lower most visual marker 119, or least numerical value 119 in the length, e.g., the visual markers representative of twenty (20) 114 and one (1) 119. The factor pair of the second highest visual marker 115 and/or numerical value is the second lowest visual marker 118 or numerical value, e.g., the visual marker of ten (10) 115 and two (2) 118, and so on. It is contemplated that the device 10 and method may be used to determine the factors and/or factor pairs of any numerical value. Indeed, because the device 10 can illustrate an infinite number of numerical values, factorization and factor pairs of high numerical values can be determined visually by simply locating the length corresponding to the high numerical value.

### Example 5

### Division

In one embodiment, because division is primarily based upon the mathematical factors of a numerical value, the device 10 and method may be used to visually teach division and/or calculate equations involving division. In principle, division may be defined as a calculation of the factor pairs of the solution of the equation. For example, in the equation 20÷4=5, the solution, four (4) 117, is the corresponding factor pair to five (5) 116 of the numerical value or length of twenty (20) 113. Using the device 10 and method, the equation 20÷4=5 can be solved and/or illustrated by determining the factor pair of four (4) 117, as previously described.

### Example 6

### Perfect Squares

Also shown in FIG. 11, the device 10 and method may be used to teach and/or determine if a numerical value is a perfect square. A perfect square is the product of a number multiplied by itself, e.g., four (4) is a perfect square of 2×2. As illustrated, numerical values that are perfect squares comprise an odd number of visual markers, mathematical factors, e.g., the length representing the numerical value four (4) 120 has three mathematical factors 121 one (1), two (2), and four (4). This is further seen upon considering the factor pairs of a perfect square, e.g., the factor pairs of four (4) are four (4) and one (1), and two (2) and two (2). The device 10 allows for a quick and simple method for determining and teaching the concept of perfect squares, square roots, and/or so forth.

For example, illustrated in FIG. 11 is a mathematical problem: name the perfect squares between the numerical values fifteen (15) 122 and twenty (20) 113. To solve the problem, an individual need only look at the device 10 and determine which lengths between fifteen (15) 122 and twenty (20) 113 comprise an odd number of mathematical factors and/or visual markers. As illustrated, the only numerical value between fifteen (15) 122 and twenty (20) 113 comprising an odd number of visual markers is sixteen (16) 123.

### Example 7

### Prime Numbers

As shown in FIG. 11, the device 10 may assist in visually teaching and illustrating numerical values that are prime numbers. A prime number is a natural number that has two distinct natural number divisors, 1 and itself. Thus, by definition a prime number has two factors. As shown, a numerical value that is a prime number is represented on the device 10 as a length having a total of two visual markers, or factors. More specifically, on the device 10, a numerical value that is a prime number includes the visual marker representative of one (1) and the visual marker representative of prime numerical value. For example, the length for the prime numerical value eleven (11) 124 is represented by the visual marker representative of eleven (11) 125 and the visual marker representative of one (1) 125.

Advantageously, the device 10 enables quick and easy recognition of prime numerical values. Because the device 10 may include an ever-increasing range of numerical values (e.g., one (1) to infinity), determining prime numerical values of larger numbers not normally recognized as prime numbers, e.g., 61, 89, 97, 101, 103, etc. is easily recognizable on the device 10, as the lengths of higher primer numerical values include only two visual makers, e.g., the visual markers representative of the numerical value or length and the visual marker corresponding to the numerical value one (1).

### Example 8

### Greatest Common Factor

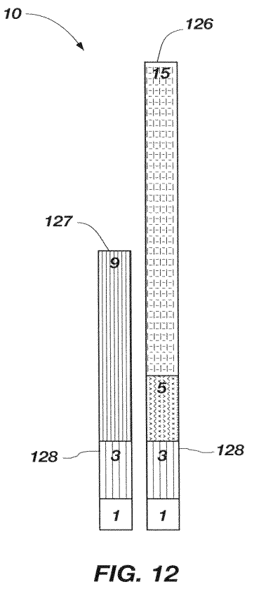

As shown in FIG. 12, the device 10 and method can assist in visually teaching and illustrating the greatest common factors (GCFs), or greatest common divisor, of two or more numerical values. The greatest common factor is the greatest, shared multiple between two numbers. For example, the common factors of the numerical values fifteen (15) and nine (9) are illustrated on the device 10 by the shared visual markers of the numerical values or lengths of fifteen (15) 126 and nine (9) 127. The GCF of fifteen (15) and nine (9) is shown as the greatest, or highest common visual marker of both lengths fifteen (15) 126 and nine (9) 127, or the visual markers representative of three (3) 128.

### Example 9

### Least Common Multiple

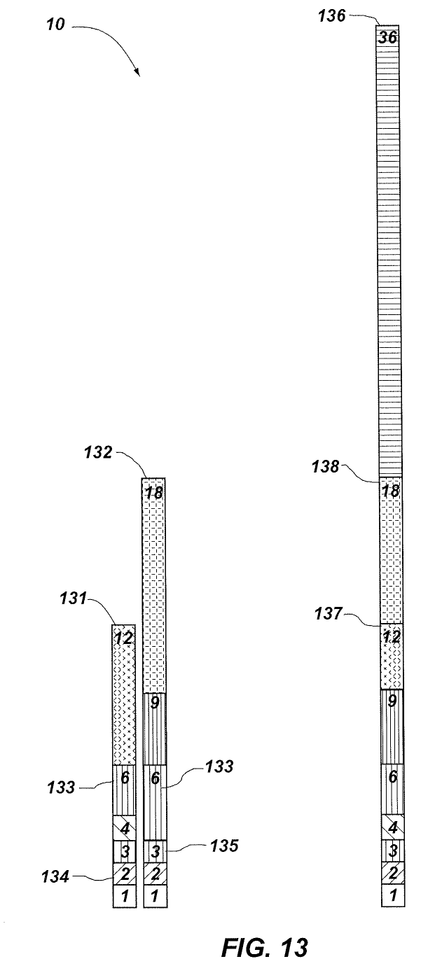

As shown in FIG. 13, the device 10 may be used to determine and/or teach the least, or lowest, common multiple of two or more numerical values. The least common multiple is the smallest multiple that two numerical values share. Typically, determining the least common multiple entails prime factorization and eliminating inapplicable mathematical factors. The device 10 provides an illustrative and simple manner in which least common multiples can be determined.

For example, to determine the least common multiple of twelve (12) and eighteen (18), the GCF of twelve (12) and eighteen (18) is determined or otherwise visualized as previously described. As shown in FIG. 13, the GCF of the lengths twelve (12) 131 and eighteen (18) 132 is six (6) 133, or the visual marker representative of six (6) 133. The next step is to determine the corresponding factor pairs of the GCF for both lengths twelve (12) 131 and eighteen (18) 132, as previously described. As shown on the device 10, the corresponding factor pairs of the GCF six (6) 133 for both twelve (12) 131 and eighteen (18) 132 are two (2) 134 and three (3) 135, respectively. The least common multiple is the product of the GCF and the corresponding factor pairs of both twelve (12) 131 and eighteen (18) 132, or 6×2×3, which equals thirty-six (36) 136. Advantageously, the device 10 provides a visual manner in which to verify any solution or determination of a least common multiple. As shown, the visual marker representative of thirty-six (36) 136 comprises the visual markers representative of twelve (12) 137 and eighteen (18) 138; further demonstrating that both twelve (12) and eighteen (18) are mathematical factors of thirty-six (36).

### Example 10

### Algebra and Linear Functions

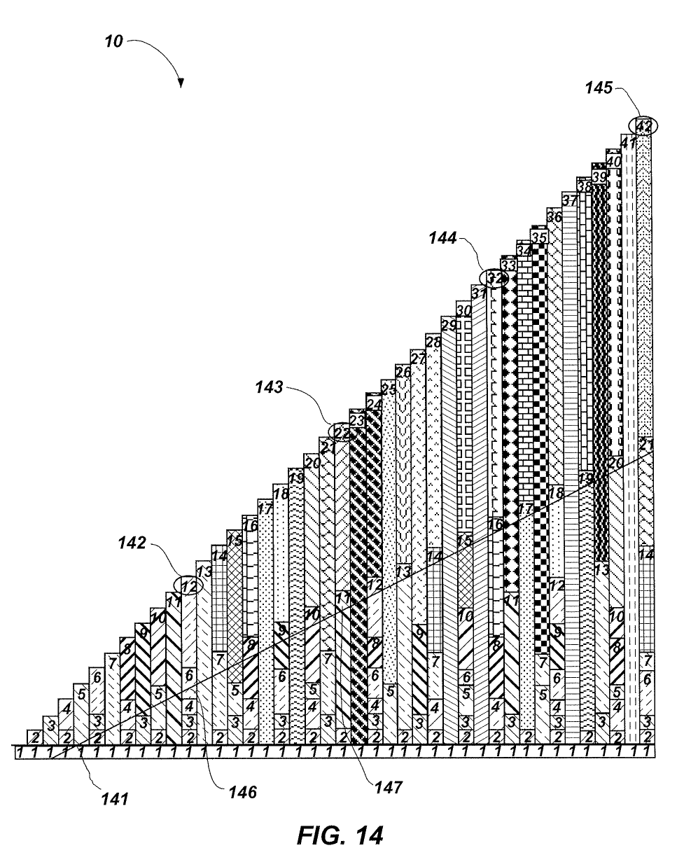

In another embodiment, shown in FIG. 14, the device 10 and method can be used to teach and calculate linear functions. Functions are relationships between numbers involving an input variable or numerical value that results in an output variable. For example, as shown, the function: f(x)=½×141 can be used to determine outputs values for the inputs twelve (12), twenty-two (22), thirty-two (32), and forty-two (42). The lengths representative of the numerical values twelve (12) 142, twenty-two (22) 143, thirty-two (32) 144, and forty-two (42) 145 are illustrated on the device 10. To determine the output value for each numerical value according to f(x)=½×141, an individual locates the length representative of the numerical values twelve (12) 142, twenty-two (22) 143, thirty-two (32) 144, and forty-two (42) 145 on the device 10, then follows the visual length until intersecting with the linear function f(x)=½×141. The output value is the numerical value represented by the visual marker that intersects with the linear function f(x)=½×141. As shown, the linear function f(x)=½×141 intersects with the input value 12, at the visual marker representative of six (6) 146. For the input value twenty-two (22) 143, the linear function 141 intersects with the input value twenty-two (22) 143 at the visual marker representative of eleven (11) 147, and so forth.

### Example 11

### Equations of Lines

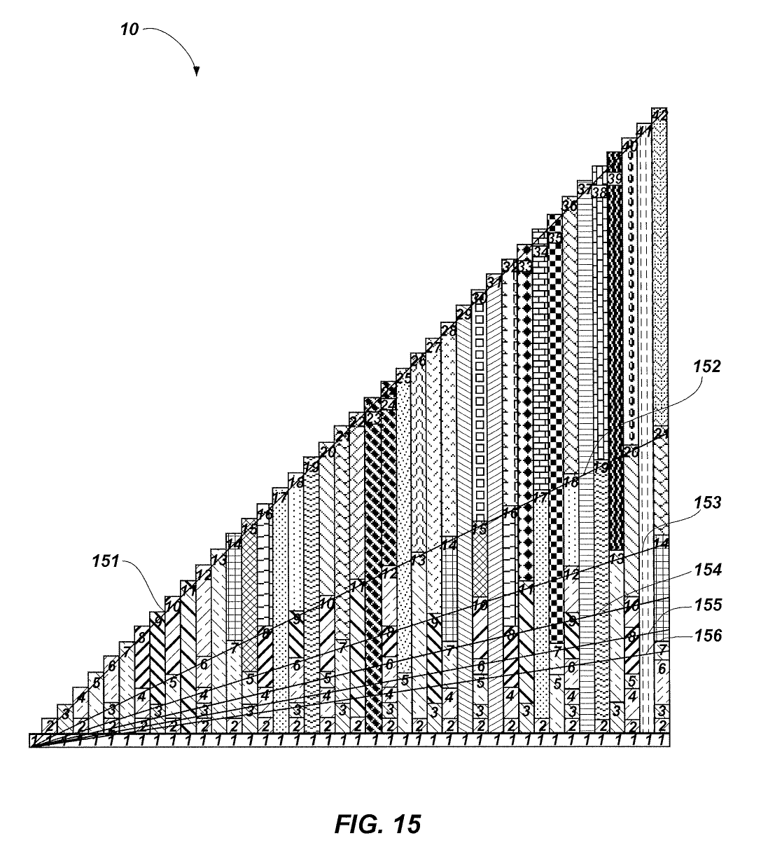

As shown in FIG. 15, the device 10 and method can be used to teach and/or illustrate linear equations. Linear equations are an integral part of algebra and are important in understanding more complex and higher mathematics. In one embodiment, the patterns and arrangements of the visual markers create the linear slopes from one (1) to infinity, from negative one (−1) to negative infinity, from ½ to 1/∂, and from −½ to negative 1/∂. Shown in FIG. 15, are exemplary line equations including: one (1) 151, one-half (½) 152, one-third (⅓) 153, one-fourth (¼) 154, one-fifth (⅕) 155, and one-sixth (⅙) 156.

### Example 12

### Geometry

In one embodiment, the device 10 and method is applicable to teach principles of geometry and to calculate equations and problems related thereto. For example, the geometric principle of similar geometrical objects can be visually shown on the device 10. Two geometrical objects are called similar if one is congruent to the result of a uniform scaling, enlarging or shrinking of the other. For example, all circles are similar to each other, all squares are similar to each other, and so forth. Two or more triangles are similar if the triangles have the same three angles.

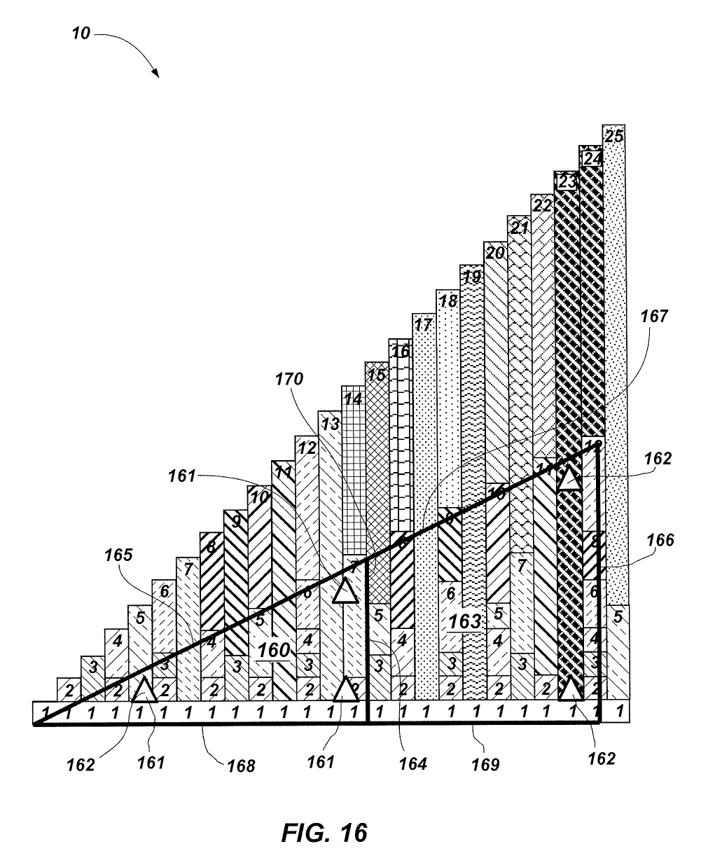

As shown in FIG. 16, the first triangle 160 includes a particular set of angles 161. The angles 161 are equal to angles 162 of the second larger triangle 163. As illustrated, the device 10 provides a visual example of the similarities between the two triangles 160, 163.

Also shown in FIG. 16, the device 10 and method may assist in determining proportional relationships between similar geometrical objects. For example, provided that two or more geometrical objects, (e.g., triangles), are similar, proportional relations can be extrapolated between them. One example is the proportion between the sides of similar triangles. As shown, a proportion may include the inverse proportion of side lengths of o 164 and h 165 from the smaller triangle 160, while taking O 166 and H 167 from the larger triangle 163. The proportions yield equations such as o164/h 165=o166/H167 with respect to their particular side lengths.

In a non-limiting example, shown in FIG. 16, the length of side o 164 can be determined provided that a 168=14, A 169=24, and O 166=12. As previously noted, the proportions yield equations such as o/h 0/H. Given these side lengths, the proportion of o/a=O/A will be the best equation to solve for the unknown side length. Through substitution, the equation becomes o/14=12/24. After cross-multiplication, we find that o 164=7. Furthermore, the side length o 164 of 7 corresponds with the position of the length o 164 on the device, and the visual marker corresponding to the numerical value seven (7) 170.

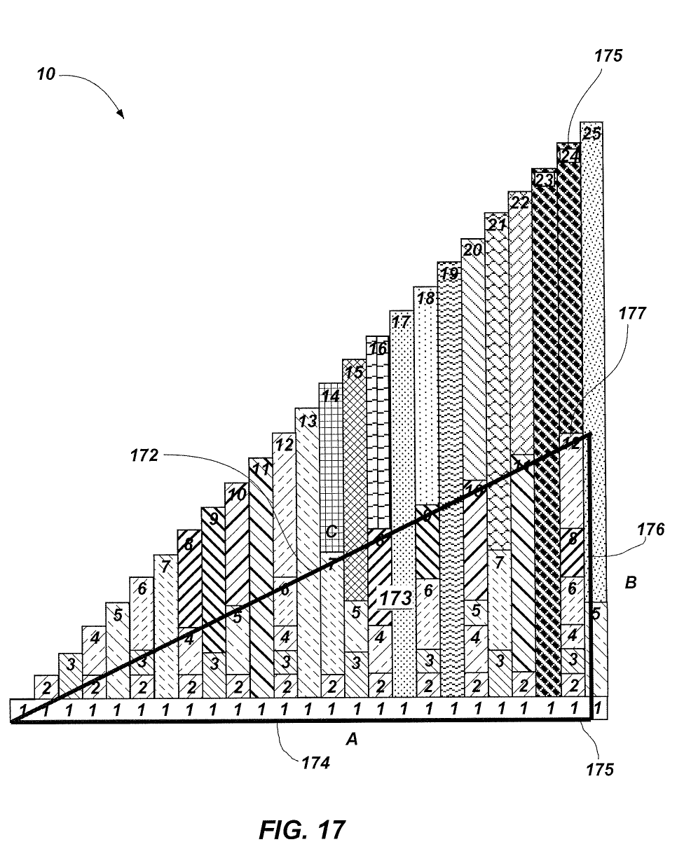

As shown in FIG. 17, the device 10 and method can visually teach and illustrate the principles of the Pythagorean Theorem, A²+B²=C², in addition to calculating equations related thereto. For example, the length of C 172 can be determined when provided with the triangle 173 together with the device 10 and method. As shown, the length of A 174 is twenty-four (24) given that it is twenty-four (24) lengths 175 of the device 10. The length of B 176 is twelve (12) as it measures twelve (12) squares or units in height and coincides with the visual marker representative of twelve (12) 177. To determine the length of C 172, the values are substituted into the Pythagorean Theorem, resulting in 12²+24²=C². The expression reduces to 720²=C², which produces C=12√5 or about 26.83. Additionally, the length of C 172 could be measured to verify the solution.

### Example 13

### Trigonometry

In one embodiment, the device 10 and method is applicable to teach principles of trigonometry and to calculate equations and problems related thereto. Similar to geometric proportions, the Sine, Cosine, and Tangent functions are a set of proportions between sides of a triangle as compared to an angle. Sine is equal to the proportion of the opposite side divided by the hypotenuse (o/h). Cosine is the adjacent divided by the hypotenuse (a/h). Tangent is the opposite divided by the adjacent (o/a).

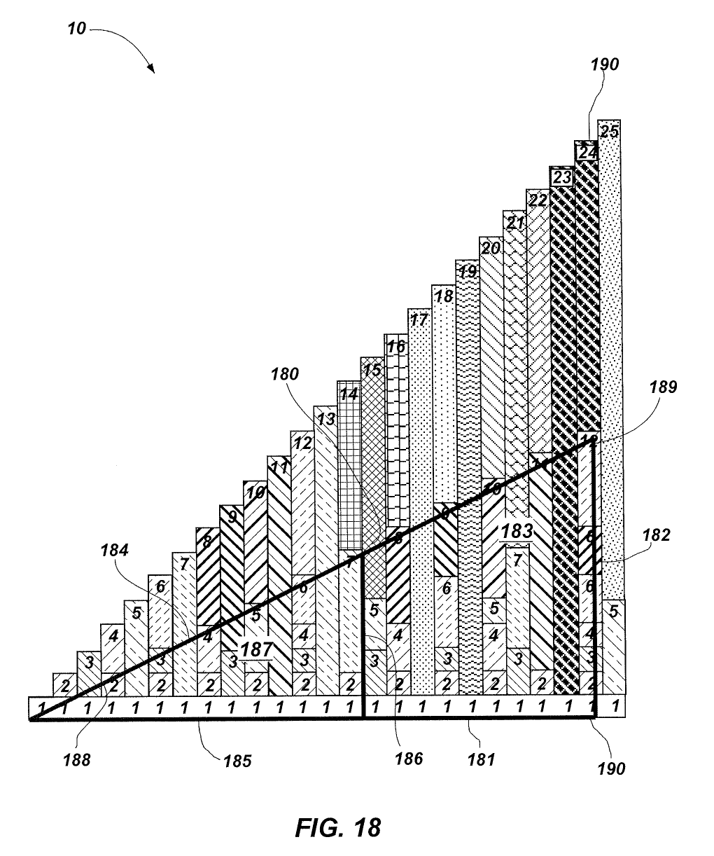

Illustrated in FIG. 18 is the exemplary problem: solve the sine, cosine and tangent proportions for the triangle (H 180, A 181, O 182) 183 and the triangle (h 184, a 185, o 186) 187 with respect to the angle 188. First the length of each corresponding side (H 180, A 181, O 182; h 184, a 185, o 186) is determined. For the larger triangle 183, the side opposite angle 188, O 182 has a length of 12. This can be seen as the device 10 illustrates the visual marker representative of 12 189. The side adjacent to the angle 188, A 181 has length of 24. The device 10 illustrates that the side adjacent the angle, A 181 ends at the 24^{th} length 190. To determine the length of the hypotenuse, a physical measurement may be taken or the Pythagorean Theorem may be used. After substituting lengths and solving for the unknown H 180, the hypotenuse measures 12√5. The hypotenuse and lengths of the smaller triangle 187 can be found using similar methods. With the substitution of the equation, the smaller triangle 187 measurements can be found, e.g., 14²+7²=h², h 184 equals 7√5. As illustrated in the table below, the lengths will be substituted for their appropriate variables to create the trigonometric proportions.

TABLE 1

| Triangle 183 | Triangle 187 |
|---|---|
| sin(188) = O/H = 12/12√5 = √5/5 | Sin(188) = o/h = 7/7√5 = √5/5 |
| cos(188) = A/H = 24/12√5 = 2√5/5 | cos(188) = a/h 14/7√5 = 2√5/5 |
| tan(188) = O/A = 12/24 = 1/2 | tan(188) = o/a = 7/14 = 1/2 |

### Example 14

### Calculus

In another embodiment, the device 10 and method are applicable to teaching and solving a variety of different types of calculus equations and principles. Some non-limiting examples applicable principles of calculus include: limits, derivatives, Riemann sums, integrals, infinite series, multi-variable calculus, etc.

In a non-limiting example, the device 10 and method may be used teach and calculate Riemann sums. In one aspect, Riemann sums are used to estimate an integral. An integral is the area under a function. Riemann sums are the basic tools for understanding the process of integration. A basic principle behind a Riemann sum is the addition of very small rectangles together to approximate an area. The device 10 and method provide an ideal tool for illustrating Riemann sums, as the device 10, in one embodiment, is arranged into rectangular components.

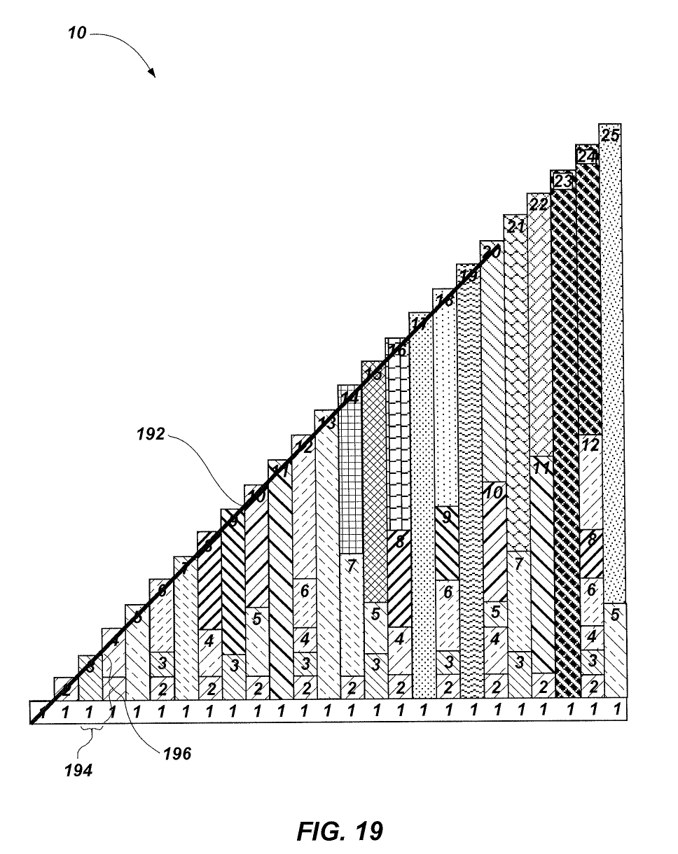

Illustrated in FIG. 19 is the exemplary problem: use Riemann Sums to approximate the Integral of the function f(x)=x from 1 to 20. The line 192 represents the function of f(x)=x from 1 to 20. The integral using Riemann Sums is equal to the sum of all the individual rectangles. Given that the area of a rectangle is equal to b×h where b is the base measurement and h is the height of the rectangle. The base measurement 194 for these rectangles is equal to 1, and the height 196 is equal to the value of each respective length 13. Accordingly, the area of all the lengths is equal to their individual value. The integral then is equal to the sum of all the numbers from 1 to 20, which is 210.

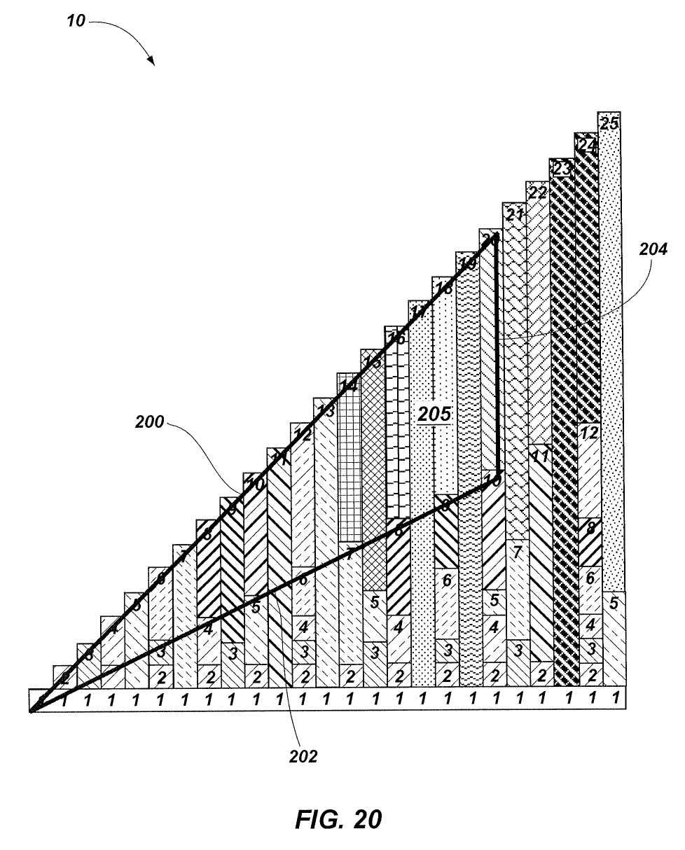

In another non-limiting example, the device 10 and method may be used to teach and calculate complex integrals, e.g., addition and/or subtraction of other functions. Illustrated in FIG. 20 is an exemplary problem: mark out the integral as a difference of area between the function f(x)=x 200 and g(x)=½x 202 evaluated from 1 to 20. The solution is illustrated as the space between the lines f(x) 200 and g(x) 202 represents the integral between the functions. The two lines show the graphed functions and the vertical line 204 represents the end of the evaluated portion and encloses the complex integral 205. Alternatively, the integral may be evaluated through the expression h(x)=x−½x.

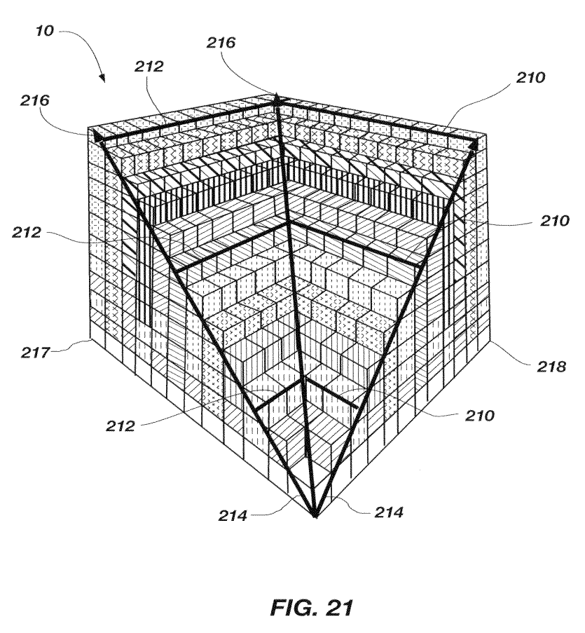

As shown in FIG. 21, the principles of multivariable calculus may be illustrated and taught using the device 10 and method. More particularly, a three-dimensional embodiment of the device 10 and method is suitable for teaching and calculating multivariable calculus. Multivariable calculus is the extension of calculus in one variable to calculus in several variables. For example, multiple integrals, or double integrals may be used to calculate the area and volume of a function.

Illustrated in FIG. 21 is an exemplary problem that demonstrates one aspect of the applicability of the device 10 and method. The problem reads: calculate the volume underneath the planes x−z=0 210, y−z=0 212, where, 0≦x≦12, 0≦y≦12, and 0≦z≦12. As shown, the plane 210 is representative of the equation x−z=0 and the plane 212 is representative of the equation y−z=0. For example, 0≦x≦12, 0≦y≦12, and 0≦z≦12 can be visualized, marked, or otherwise calculated on the device 10 using the visual markers representative of the numerical values x=0 214, y=0 214, and z=0 214. Also shown are the visual marker representative of the numerical values z=12 216, x=12 217, y=12 218. The desired volume underneath the planes 210, 212 equals the volumes underneath the two planes 210, 212.

### Example 15

### Linear Algebra

In a further embodiment, the device 10 and method are applicable to teaching and solving a variety of different types of linear algebra equations and principles. Linear algebra is the basic math of multiple dimensions, including the study of vectors, vector spaces, or linear spaces, linear maps, and systems of linear equations. Some non-limiting applications of the device 10 and method include: vectors; addition, subtraction, multiplication, and division of vectors; linear projections; orthogonality of vectors; and so forth.

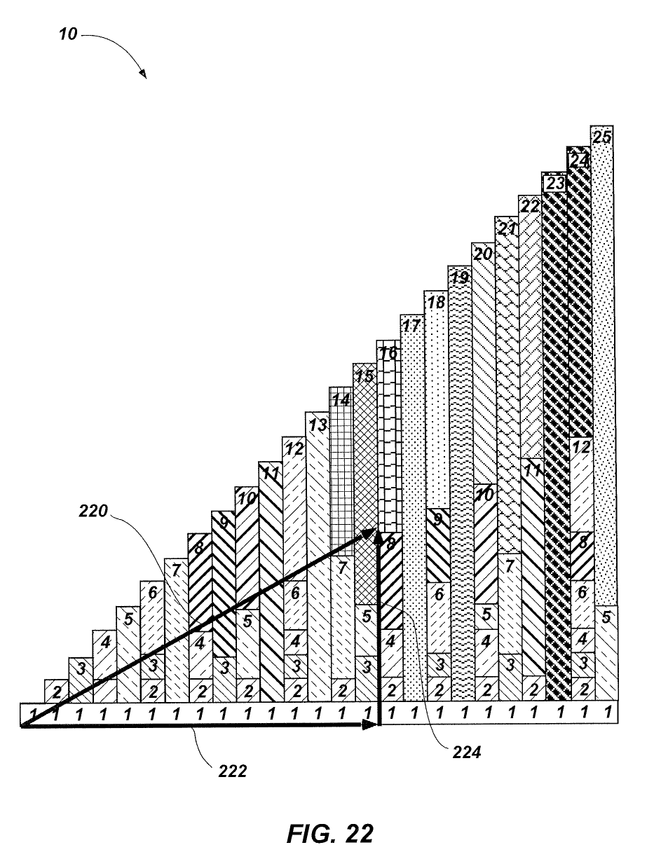

Illustrated in FIG. 22 is an exemplary problem that demonstrates the applicability of the device 10 and method. The problem reads: separate the vector <15, 8> into its axial components. As shown, the original vector <15, 8> 220 can be visually separated into its axial components x₁ and x₂ using the device 10. The x₁ component <15, 0> 222 is located on the device 10 by finding the visual markers and lengths representative of the coordinates x₁. The x₂ component <0, 8> 224 is located on the device 10 in a similar manner to x₁

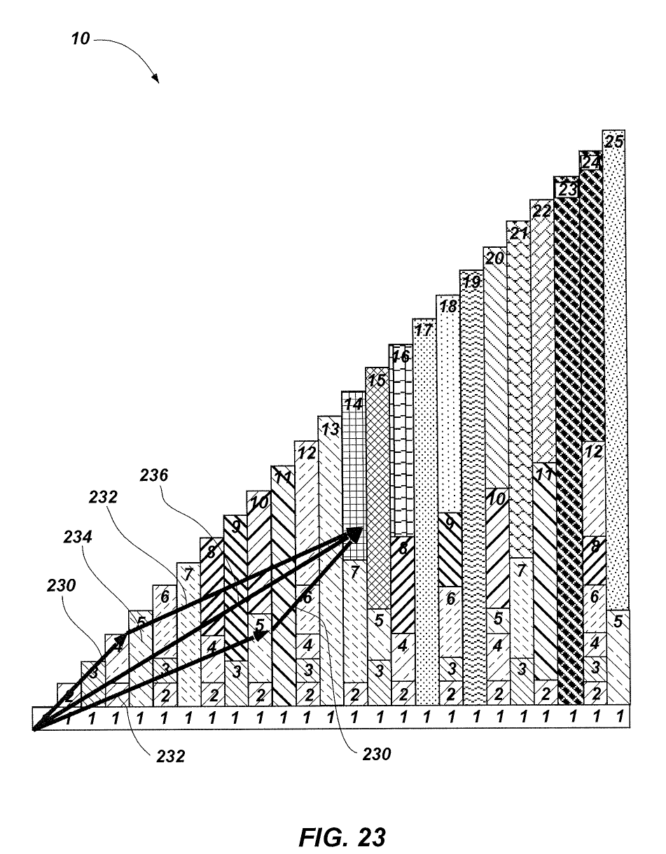

As shown in FIG. 23, the device 10 and method are applicable to vector addition and subtraction. Vector addition and subtraction are a basic function of linear algebra and assist in understanding the complexity of infinite dimensional analysis. For example, rules of a two dimensional space, or R², can be applied in higher dimensions. The device 10 and method can assist in understanding many of the rules regarding the manipulation of vectors in R₂, and can provide a basis for an understanding of more complex principles.

In one non-limiting example, the device 10 and method may illustrate the use of the parallelogram law, or rule. The parallelogram law states that the sum of the squares of the length of the four sides of a parallelogram equals the sum of the square of the lengths of the two diagonals, or

(AB)²+(BC)²+(CD)²+(DA)²=(AC)²+(BD)²

Illustrated in FIG. 23 is an exemplary problem that demonstrates the applicability of the device 10 and method to vector addition. The problem reads: solve the vector equation <4, 4>+<10, 4>=?. Shown are the vectors <4, 4> 230 and <10, 4 232. In applying the parallelogram rule with the device 10 and method to solve the problem, the beginning of vector touches or connects to the end of another vector. As shown, the beginning of the <10, 4> vector 232 connects to the tip of the <4, 4> vector 230. Similarly, the beginning of the <4, 4> vector 230 connects to the tip of the <10, 4> vector 232, thus forming a parallelogram 234. The sum of the two vectors 230, 232 equals the vector <14, 8> 236.

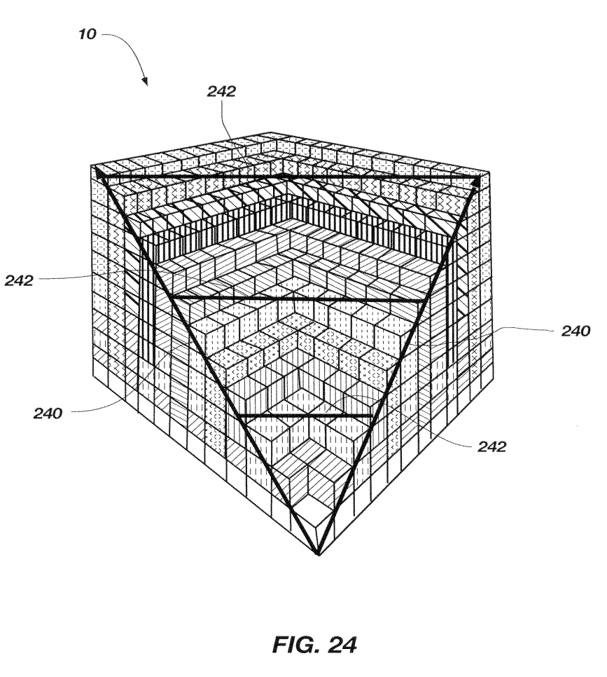

The device 10 and method are additionally applicable to linear algebra principles and equations on a three-dimensional level, such as, but not limited to, linear transformations, identification of vector spaces, and equations of planes. Shown in FIG. 24 is an exemplary problem that demonstrates one aspect of the applicability of the device 10 and method on a three-dimensional level. The problem reads: mark out the plane given by the equation x+y−z=0. As shown, the two vectors 240 illustrate the equation x+y−z=0. The lines 242 illustrate the portions of the plane x+y−z=0.

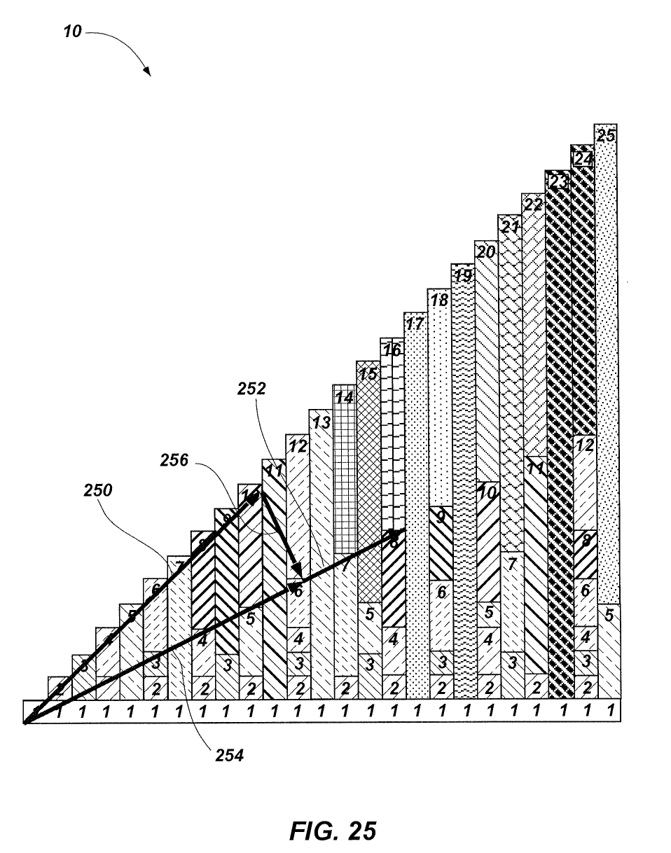

As shown in FIG. 25, the device 10 and method are applicable to teaching and determining linear projections, linear transformations, and/or linear maps. A linear projection of a first vector onto a second vector is a transformation that takes the relative magnitude of the first vector and combines it with the direction of the second vector. Provided that the first vector and second vector are equal to the variable “u” and “v,” respectively, a projection equation may be embodied in:

[(u·v)/|v|²]·v

The device 10 and method may simplify complex equations by providing a visual representation of the complex equations.

Illustrated in FIG. 25 is the problem: find the projection of the vector <10, 10> onto <16, 8>. Shown are the vectors <10, 10> 250 and <16, 8> 252. The projection <12, 6> 254 may be found by taking the magnitude of the vector <10, 10> 250 with regard to the vector <16, 8> 252.

As shown in FIG. 25, the device 10 and method are applicable to teaching and visually depicting orthogonal, or perpendicular, angles. More particularly, the device 10 assists in determining if one or more vectors create an orthogonal angle. As is understood in the art, a vector minus its projection is orthogonal to the directional vector. As shown, an original vector <10, 10> 250 has a projection 254 onto the <16, 8> vector 252. The difference between the <10, 10> vector 250 and the projection 254 is the vector 256. The vector 256 is orthogonal to the <16, 8> vector 252 and the projection vector 254.

### Example 16

### Physics

In yet another embodiment, the device 10 and method are applicable in teaching principles and problems in the areas of physics. Some non-limiting examples of applicable physics principles and problems include: force, frequency, wavelength, and so forth.

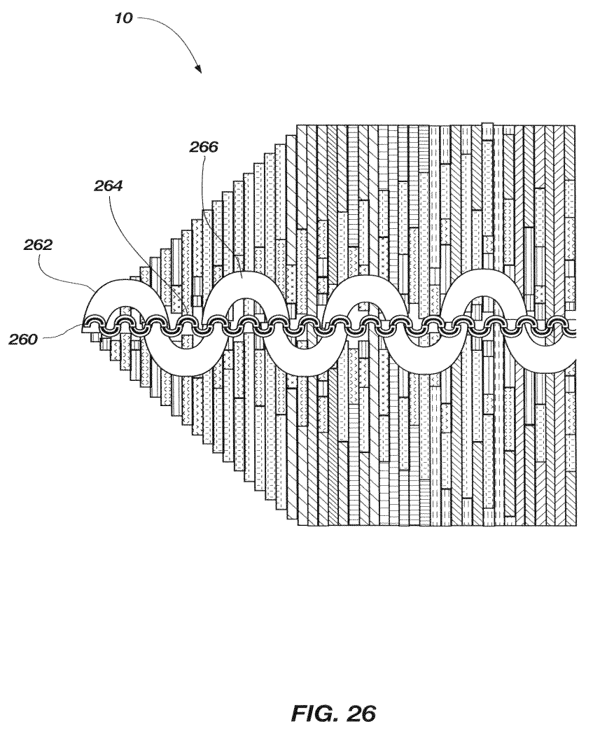

As shown in FIG. 26, the device 10 and method are applicable to teaching and visually depicting frequency. Frequency measures a number of occurrences of a repeating event per unit time. In one aspect, frequency assists in measuring the wave-like nature of electromagnetic radiation, e.g., visible light, radio waves, infrared, x-rays, ultraviolet light, etc. Additionally, frequency may be used to calculate energy levels. The numerical values of the device 10 may include a range or spectrum of frequencies. For example, the numerical value and visual marker of two (2) has a frequency of two (2), the numerical value visual marker of three (3) has a frequency of three (3), and so on

Illustrated in FIG. 26 are two exemplary wave functions 260, 262. The first wave function 262 is sine wave having a frequency of seven (7). The second wave function 260 is sine wave having a frequency of two (2). As can be seen, the frequency value for the first and second wave function is visually depicted, as the first and second wave functions extend to and are repeated across the device 10 to the visual markers representative of seven (7) 266 and two (2) 264, respectively.

In another embodiment, the device 10 and method is applicable to teaching and calculating force and the application of forces on objects, e.g., gravity, friction, etc. It is commonly understood that force is what can cause an object with a mass to accelerate. Force has both a magnitude and a direction, and is commonly expressed as a vector quantity. As previously described the device 10 and method are particularly adept at teaching and calculating vectors quantities and linear algebraic principles.

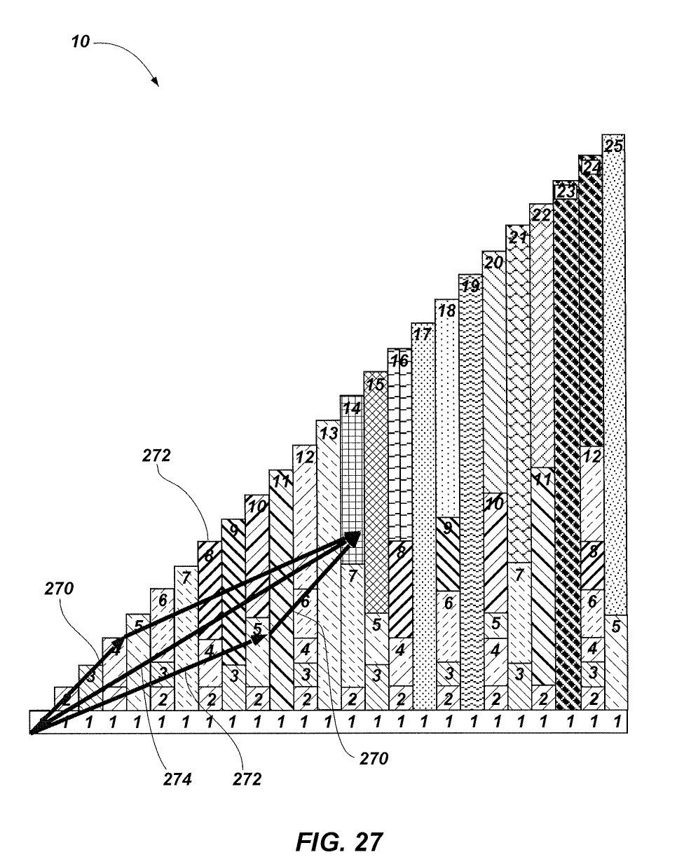

As shown in FIG. 27 is an exemplary embodiment of a first and second force 270, 272 and their representative vectors 270, 272, acting on an object to produce a third vector 274. As shown, the third vector 274 comprises the sum of the first and second vectors 270, 272, or the magnitude of the forces acting on the object. It is contemplated that the device 10 and method may be particularly applicable in determining and teaching forces and their magnitude on a three-dimensional spectrum 10 as described herein.

### Example 17

### Engineering

In yet another embodiment, the device 10 and method can be used for engineering applications. Some non-limiting examples of engineering applications include: squaring of buildings, determining stress tolerance for materials and objects, determining forces upon objects, and so forth.

In a non-limiting example, the device 10 may be used to assist in the squaring of a building. One purpose in squaring a building is to verify that a building forms a ninety degree angle with other buildings and the ground. This can assist in minimizing stress on the building structure. Squaring a building typically involves using trigonometric proportions to calculate heights and lengths of building, in addition to angles.

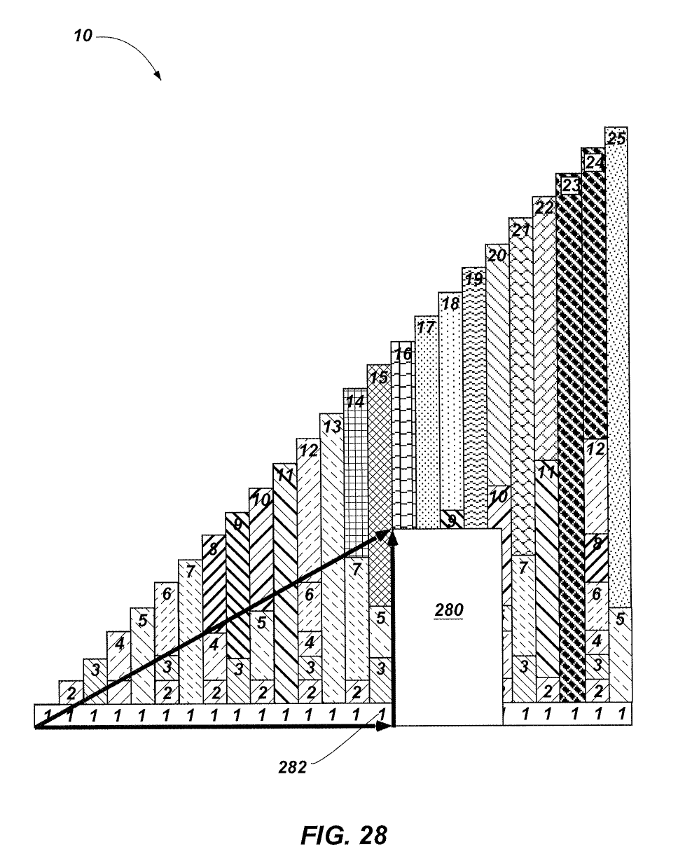

As shown in FIG. 28 is an exemplary use of the device 10 in squaring a building. The rectangle 280 represents a building or other structure. By measuring the lengths of the sides, the angles 282 can be calculated to see if the building 280 or other structure is squared off.

Although the foregoing description includes many specifics, these should not be construed as limiting the scope of the present invention but, merely, as providing illustrations of some of the presently preferred embodiments. Similarly, other embodiments of the invention may be devised which do not depart from the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

1. A device for teaching and/or calculating mathematical equations and principles, the device comprising:
a first numerical value represented by a first length, the first length comprising a first visual marker representative of the first numerical value; and
a second numerical value greater than the first numerical value represented by a second length, the second length comprising a second visual marker representative of a second numerical value;
wherein the first length and the second length are increasingly or decreasingly displayed as a spectrum, and wherein the first visual marker is repeatedly displayed on the spectrum in a pattern corresponding to the first numerical value.

2. The device of claim 1, wherein each visual marker comprises a distinct color.

3. The device of claim 1, wherein each numerical value comprises an integer.

4. The device of claim 1, wherein the first length further comprises a third visual marker representative of a third numerical value, wherein the third numerical value comprises a mathematical factor of the first numerical value.

5. The device of claim 1, wherein the first visual marker and the second visual marker each further comprise a printed number corresponding to the first numerical value and the second numerical value, respectively.

6. A device for teaching and/or calculating mathematical equations, the device configured to display a plurality of increasing numerical values as a spectrum, each numerical value represented by a distinct length, each distinct length comprising distinct visual markers representative of mathematical factors of the numerical value.

7. The device of claim 6 further configured to display the numerical value corresponding to each distinct visual marker.

8. A device for teaching, solving, and/or illustrating mathematical principles and equations, the device comprising a set of increasing numerical values arrayed on a spectrum, each numerical value represented by a length, each length comprising a visual marker representative of the numerical value; wherein the visual marker is repeatedly displayed on the spectrum in a pattern corresponding to the visual marker's numerical value.

9. The device of claim 8, wherein the visual marker comprises a color.

10. The device of claim 8, wherein the device further comprises a Cartesian coordinate system.

11. The device of claim 10, wherein the Cartesian coordinate system is two-dimensional.

12. The device of claim 10, wherein the Cartesian coordinate system is three-dimensional.

13. A device for teaching, solving, and/or illustrating mathematical principles and equations, the device comprising a set of increasing numerical values on a spectrum, each numerical value represented by a length, each length comprising distinct visual markers representative of mathematical factors of the numerical value.

14. A method for teaching, solving, and/or illustrating mathematical principles, the method comprising:
assigning a first numerical value a first visual marker and a first length;
assigning a second numerical value greater than the first numerical value a second visual marker and a second length;
displaying the first and second lengths as a spectrum in accordance with the first numerical value and the second numerical value; and
repeatedly displaying the first visual marker along the spectrum in a pattern corresponding to the first numerical value.

15. The method according to claim 14, wherein the first visual marker and the second visual marker each comprises a distinct color.

16. The method according to claim 14, wherein the first numerical value and the second numerical value each comprises an integer.

17. The method according to claim 14, further comprising visually displaying the first and second numerical value.

18. The method according to claim 14, further comprising incorporating at least a third visual marker at the first length, the third visual marker representative of a third numerical value, wherein the third numerical value is a mathematical factor of the first numerical value.

19. A computer-media storage medium storing instructions that, when executed by a processor, cause the processor to perform instructions for operating a spectrum for teaching and/or calculating mathematical principles and/or equations, the instructions comprising:
assigning a first numerical value a first visual marker and a first length;
assigning a second numerical value greater than the first numerical value a second visual marker and a second length;
displaying the first and second lengths as a spectrum in accordance with the first numerical value and the second numerical value; and
repeatedly displaying the first visual marker along the spectrum in a pattern corresponding to the first numerical value.

20. The computer-media storage medium of claim 19, further comprising displaying the first and second numerical values.
